(19) United States
(12) Patent Application Publication
(10) Pub. No.: US 2015/0362159 A1
(43) Pub. Date: Dec. 17, 2015

(54) Magnetic Trim System for Luminaires

(71) Applicant: Bulbrite Industries, Inc., Moonachie, NJ (US)

(72) Inventor: Jeremy Ludyjan, Moonachie, NJ (US)

(21) Appl. No.: 14/740,130

(22) Filed: Jun. 15, 2015

Related U.S. Application Data
(60) Provisional application No. 62/012,347, filed on Jun. 14, 2014.

(51) Int. Cl. F21V 17/10; F21V 23/06; F21K 99/00; F21V 23/00; F21V 19/00; F21S 8/02

(52) U.S. Cl. CPC F21V 17/105; F21V 19/001; F21S 8/02; F21K 9/30; F21K 9/50; F21V 23/001; F21V 23/06; F21Y 2101/02

(57) ABSTRACT

A magnetic retrofit trim system, kit and method for installing retrofit system for luminaires. The system comprising: a housing configured to house a magnetically attached light module, particularly an LED light engine, to an inside of the housing; a removably attachable reflector; and a removably attachable trim. The reflector and trim are magnetically and separately attachable to the housing without using tools via magnets on the housing. The housing is configured to house a driver and electrical wiring/cable for connection to the light module and to an existing lighting fixture; the housing having one or more tension springs/blades on an outer surface of the housing providing secure attachment to the inner surface of a can in the lighting fixture. The system is installed where both trims and reflectors are manually adjustable and interchangeable with other trims and reflectors, before or after installation in the lighting fixture, without use of tools.

### CROSS-REFERENCE TO RELATED APPLICATION

This application claims the benefit of U.S. Provisional Application No. 62/012,347, filed Jun. 14, 2014, which is hereby incorporated by reference in its entirety.

### BACKGROUND OF THE INVENTION

1. Field of the Invention

The present invention relates to lighting. More particularly, the present invention to a magnetic downlight system for luminaires having a housing adapted with removably attachable and interchangeable reflectors and trims.

2. Background

The ability to change or customize trims for luminaires such as in recessed lights or downlights is important for the overall look and feel of lighting. Trims and reflectors or baffles come in various sizes, shapes and colors to meet a customer's design needs. Changing trims, reflectors and housings also affect light output and the illumination of a space. Typically, trims and reflectors are permanently attached to housings and not easily replaceable without changing the entire lighting fixture. Some attempts to interchange trims have been made to mechanically attach trims with a twist and lock mechanism. However, with such products, when the luminaire is installed, it is quite difficult to change the trims with a twist-and-lock mechanism. Such a twist-and-lock mechanism is less forgiving on an imperfect ceiling and may not sit flush against the surface. Other products use screws, adaptors, and other hardware requiring additional tools, parts and effort to install, making it cumbersome to replace trims, especially when the luminaire has been installed.

Accordingly, there is a need for easily and efficiently changing lighting trims and reflectors without the need for tools. This allows end users the option to update looks easily. There is a need to provide users with the ability to interchange different shaped reflectors and trims, such as a square or round trim without changing the respective fixtures.

As many lighting fixtures come factory assembled with the trims and reflectors in place, there is therefore a need for fast and easy assembly at the point of sale. End users desire quick assembly or do-it-yourself assembly that is cost effective while having an equal sturdiness, mounted security and look as compared to factory assembled items.

### SUMMARY

According to an embodiment of the invention, there is a trim system for luminaires comprising: a housing unit having a rear end and a front end, the front end having a can, the can having a recessed internal surface within which a magnetic socket resides and a flange on an outermost front surface of the can, a connector cable having a first end and a second end, the first end terminating with a plug outside the housing unit, and the second end connected through the rear end of the housing unit for connection with the magnetic socket; a light module, removably and magnetically attachable to the magnetic socket on the recessed internal surface of the can; a removably attachable reflector positioned inside the can abutting the flange, the reflector having an opening aligned over the light module; and a removably attachable trim abutting the reflector, positioned covering the flange and magnetically attached to the flange. The housing unit may be configured for insertion into an existing lighting fixture, for example a downlight.

In further embodiments of the present invention, the housing unit is secured to an inside of a lighting fixture via one or more tensioned springs protruding from an outer surface of the housing unit. In another embodiment, the housing unit further comprises a driver electrically connected to the light module for controlling power to the light module.

According to an embodiment of the invention, the system further comprises at at least one magnet disposed thereon or therein the flange. The front surface of the flange may comprise at least two sets of grooves. According to embodiments, one set of grooves may correspond to a shape for a round reflector and another set of grooves may correspond to a shape for a square reflector. In yet another embodiment, the reflector may comprise a reflector flange to rest flush against the flange of the housing when the reflector is disposed inside the can of the housing.

According to embodiments of the present invention, the reflector is a magnetic material; the trim is a magnetic material. The reflector may comprise a round or square shaped reflector; the trim may comprise a round or square shape; and the trim ring and reflector are separately interchangeable and removable from the system without the use of tools. In yet other embodiments of the invention, the reflector and/or the trim has a coating treatment.

According to an embodiment of the invention, there is a housing adapted for use in a trim system for luminaires, the housing comprising: a recessed can having a rear end, a front end, and a recessed internal surface; a flange extending from an outermost perimeter of the front end; a magnetic socket provided on the internal surface configured for contact with a removable magnetic light module; a connector cable having a first end and a second end, the first end terminating with a plug outside the housing, and the second end connected through the rear end of the housing for electrical connection with the magnetic socket; and one or more tensioned springs provided on an outer surface of the housing; wherein the flange is configured for receiving a removable reflector abutting the flange over the internal surface, and configured for magnetically receiving a removable trim covering the flange.

In accordance with some embodiments of the present invention, there is a method of installing a trim system as described above, the method comprising: attaching the plug of the connector cable to an electrical socket of a lighting fixture; compressing the at least one spring while pushing the housing unit, rear surface first, into the lighting fixture; aligning and contacting the light module against the magnetic socket of the can; holding the trim such that an inner facing side of the trim faces the flange; resting the reflector against the trim such that an outer facing side of the reflector is flush against the inner facing side of the trim; and moving both the trim with reflector towards the flange until the trim magnetically attaches against the flange.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a front view of the housing with a light engine of the magnetic trim system for luminaires, according to an embodiment of the present invention.

FIG. 2 is a front view of the magnetic trim system for luminaires with a detached round reflector and round trim, according to an embodiment of the present invention.

FIG. 3 is a front view of the magnetic trim system for luminaires in assembled form, according to an embodiment of the present invention.

FIG. 4 is a front view of the magnetic trim system for luminaires in assembled form, according to another embodiment of the present invention.

FIG. 5 is a front view of the magnetic trim system for luminaires with a detached square reflector and square trim, according to an embodiment of the present invention.

FIG. 6 is a front view of the magnetic trim system for luminaires of FIG. 5 in assembled form, according to an embodiment of the present invention.

FIG. 7 is a front view of the housing of the magnetic trim system for luminaires, according to an embodiment of the present invention.

FIG. 8 is a side view of the housing of the magnetic trim system for luminaires of FIG. 7 in accordance with an embodiment of the present invention.

FIG. 9 is a side view of the housing shown in FIG. 1 in accordance with an embodiment of the present invention.

FIG. 10 is another side view of the housing shown in FIG. 1 in accordance with an embodiment of the present invention.

FIG. 11 is an exploded perspective view of a magnetic trim system for luminaires of FIG. 3, according to an embodiment of the present invention.

FIG. 12 is an exploded perspective view of a magnetic trim system for luminaires of FIG. 6, according to an embodiment of the present invention.

FIG. 13 is an exploded view of a magnetic trim system for luminaires for installing into an existing lighting fixture, according to an embodiment of the present invention.

FIG. 14 is a side view of the housing of a magnetic trim system for luminaires of FIG. 13, according to an embodiment of the present invention.

FIG. 15 shows the housing of FIG. 14 with its cover removed from the can, revealing the driver of a magnetic trim system for luminaires, according to an embodiment of the present invention.

FIG. 16 is a side view of the housing shown in FIG. 15 revealing the driver of a magnetic trim system for luminaires, according to an embodiment of the present invention.

FIG. 17 is a perspective view of a magnetic light module for use with the housing of a magnetic trim system for luminaires, according to an embodiment of the present invention.

FIG. 18 is a side view of a magnetic light module as shown in FIG. 17, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

According to embodiments of the present invention, there is described a magnetic trim system for luminaires. In particular, the luminaires include recessed lights, downlights, high hat lighting, recessed can lighting and the like. According to embodiments, there is a retrofit kit for installing LED modules for downlights, having a magnetic trim system. The magnetic trim system for luminaires is used to easily change trims and reflectors without the necessity of removing the entire light fixture from the ceiling or panel, and without the use of tools. According to embodiments, the system comprises trims and reflectors that are magnetically attached to a novel housing and allows for mixing and matching different shaped trims as well as reflectors separately. For example, a round shaped trim may be interchanged with a square shaped trim, or with other colored or patterned trims; or a round reflector may be interchanged with a square reflector, or with other colored or patterned reflectors; or both the trim and reflector may be interchanged with other trims and reflectors at the same time. Changing either or both the trim and reflector is conveniently and quickly accomplished without the use of tools.

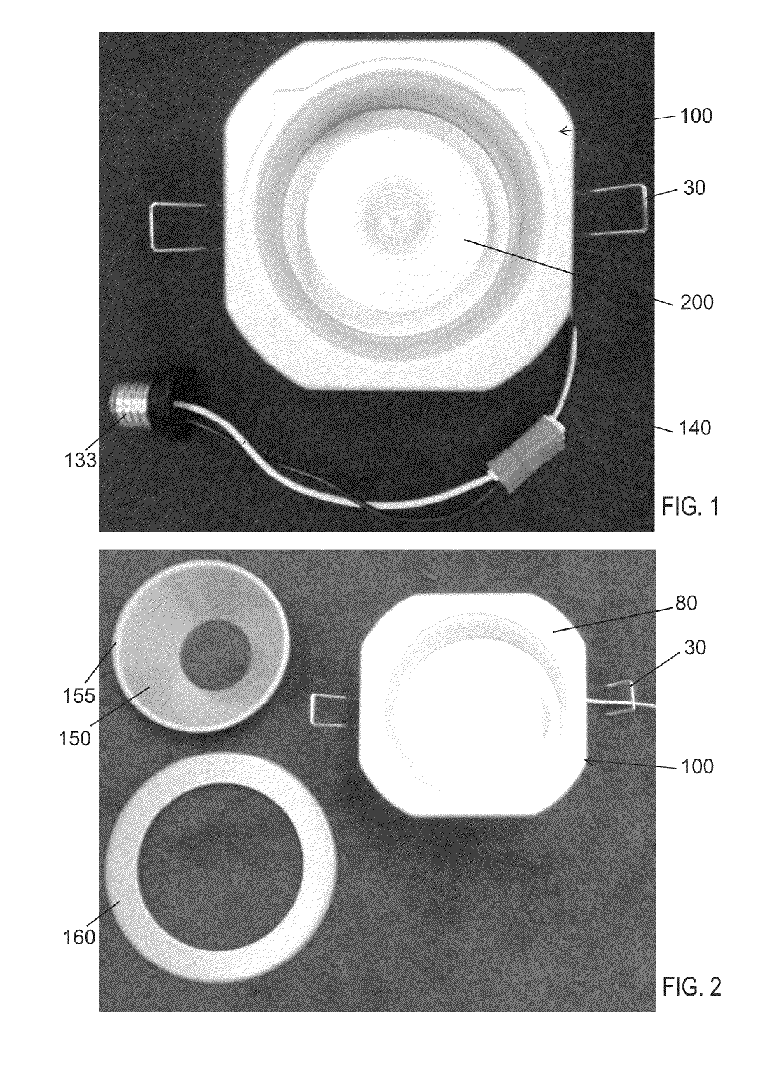

FIG. 1 illustrates a housing 100 of the trim system for luminaires, according to an embodiment of the present invention. The housing 100 shown includes a light source, particularly a magnetic LED light engine 200 which makes magnetic contact with the recessed internal surface of the housing. The housing 100 comprises a connector cable 140 terminating at one end with a plug 133 adapted for connection with the socket of a lighting fixture. One or more tensioned springs 30 are located on an outer surface of the housing 100 for secure mounting inside a recessed can of a lighting fixture. The housing 100 of the system (also referred to as the housing unit 100) is configured to accommodate attaching either round or square trims to the housing. Other shaped trims are possible due to the housing configuration. In conventional systems, a housing with permanently integral round reflector has a round trim and a housing with an permanently integral square reflector has a square trim. Accordingly, the embodiments of the present invention solve the problem of interchangeability of trims and reflectors and provide for a more universal housing. The system provides for easily removable and replaceable trims and reflectors.

FIG. 2 is a front view of a trim system for luminaires 1 with a reflector, in this embodiment, a conical shaped reflector 150 (e.g. frustoconical shape) and a trim, in this embodiment, a round trim 160 disengaged from one another and from the housing 100 according to an embodiment of the present invention. The round trim 160 magnetically attaches to a flange 80 of the housing 100 with the conical shaped reflector 150 positioned between the round trim 160 and flange 80 such that all openings over the light module 200 are aligned. The reflector 150 further comprises a reflector flange 155 on the outermost edge which fits flush atop the flange 80 of the housing when the reflector is inserted into the housing 100. The round trim 160 can be magnetically attached to the flange 80 and may also be showcased on the housing 100 without the conical shaped reflector 150.

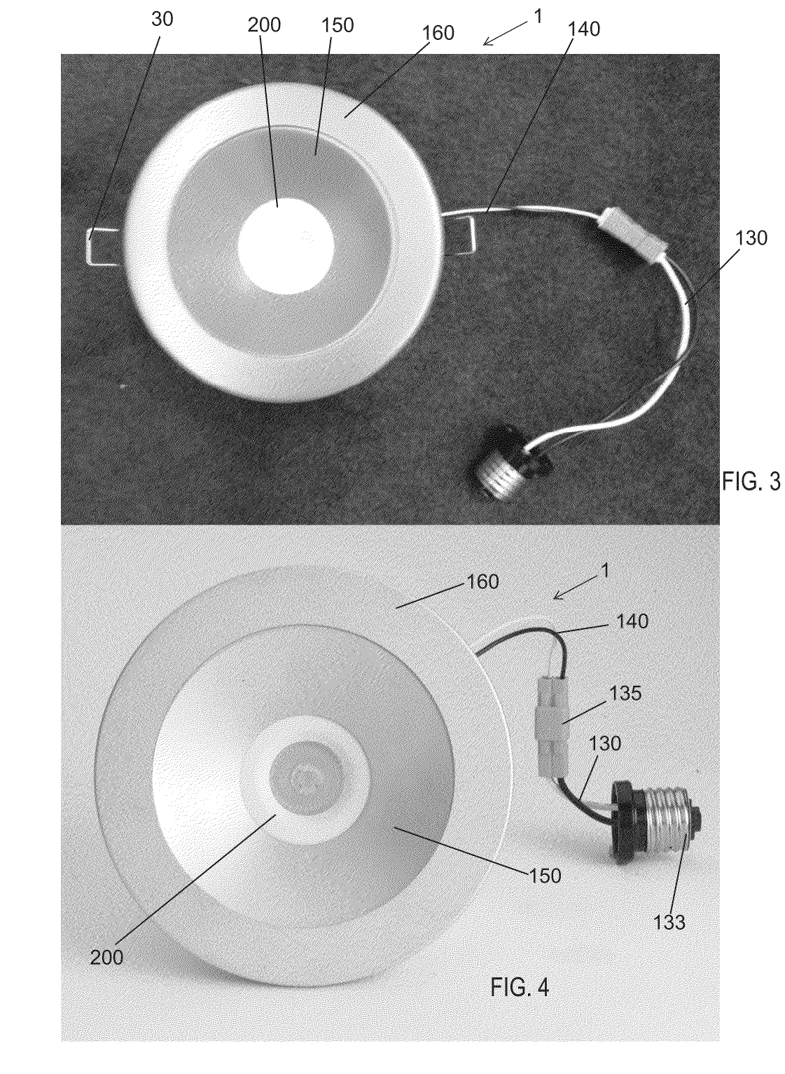

FIG. 3 is a front view of the assembled trim system for luminaires 1 according to an embodiment of the present invention. The trim system for luminaires 1 has a conical shaped reflector 150 that can be made of aluminum sheet, but can also be made of other magnetic or non-magnetic materials. The round trim 160 can be made of steel such as CRS, but can also be made of other magnetic materials. The conical reflector 150 and round trim 160 can be coated with or formed in a variety of colors, including many highly desired colors of white, bronze, chrome, black, or brushed nickel. Other colors are of course contemplated as color or designs using color and texture are possible according to embodiments of the present invention. The conical reflector 150 and round trim 160 can be coated with a treatment or formed in a variety of colors, such as white, bronze, chrome, black or brushed nickel. The conical reflector 150 and round trim 160 can also be of different shapes and sizes.

The light source, can be an LED light module/engine 200 with various lighting parameter options. The light module 200 is interchangeable with other trim system for luminaires 1. The light module 200 is engaged to the inside of the housing 100 by magnetic contact to an internal surface of the housing 100. The light module 200 is powered through a wire 140 connected to a connector cable 130 via a connector such as a snap lock connector 135. The first end connector cable which terminates with a plug 133 is attached to an electrical socket of a recessed can housed within a lighting fixture, such as downlight attached to a ceiling. One or more tensioned springs 30 are positioned on an outer surface of the housing 100 for securely holding the housing 100 inside the lighting fixture. The springs 30 are formed of steel but can be made of other material besides steel.

FIG. 4 is another front view of the trim system for luminaires 1 as shown in FIG. 3, with tension springs not visible. The one of more springs 30 can be permanently attached or be detachable to the outer surface of the housing of the trim system for luminaires 1 and may be formed in a variety of shapes and configurations so long as it provides a spring-like tensioned resistance. The spring 30 holds the trim system for luminaires 1 in place in the ceiling by applied tension against the inside surface of the can in the lighting fixture and/or may contact corresponding hold points inside the can.

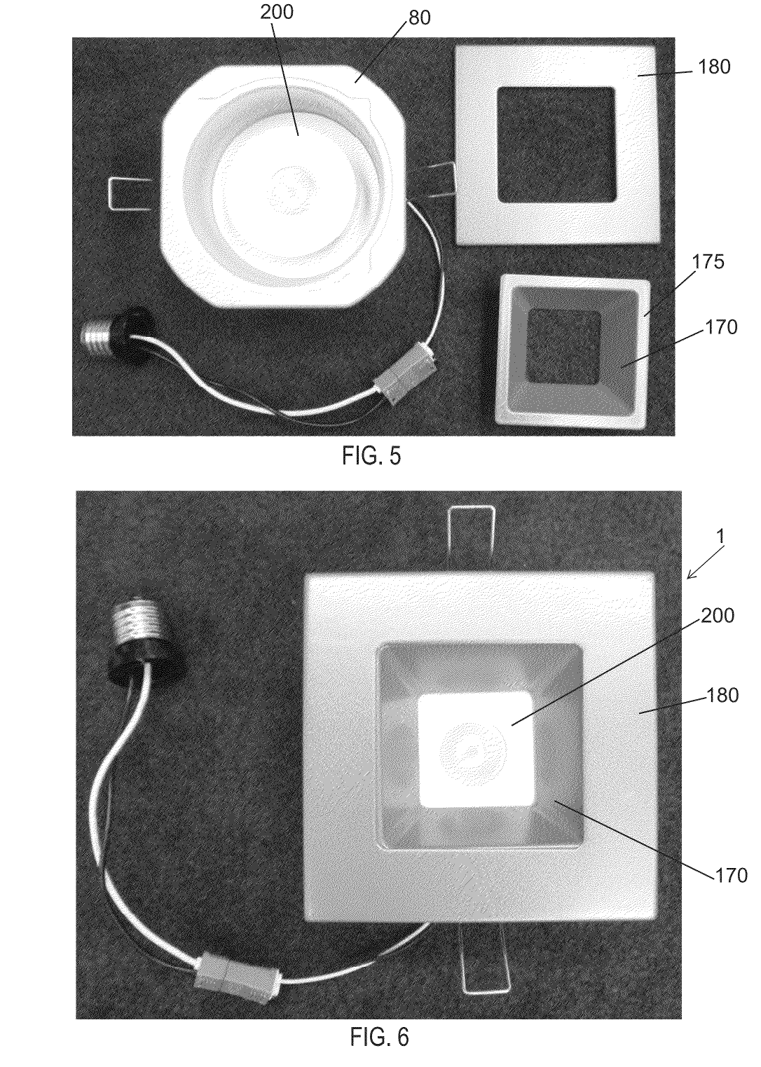

FIG. 5 is a front view of a trim system for luminaires 1 with a square shaped reflector 170 (e.g. square frustum shape) and a square trim 180 disengaged from one another and from the housing 100 according to another embodiment of the present invention. The square trim 180 magnetically attaches to the flange 80 of the housing with the square shaped reflector 170 positioned between the square trim 180 and flange 80 such that all openings over the light module 200 are aligned. The reflector 170 further comprises a reflector flange 175 on the outermost edge which fits flush atop the flange 80 of the housing when the reflector is inserted into the housing 100. The square trim 180 can be magnetically attached to the flange 80 and may also be showcased on the housing 100 without the square shaped reflector 170.

The square shaped reflector 170 or conical shaped reflector 150 and round trim 160 or square trim 180 can be mixed and matched. In one embodiment, a square shaped reflector 170 can be used with a round trim 160. In yet another embodiment, a conical shaped reflector 150 can be used with a square trim 180. With the versatility of removable and interchangeable trims and reflectors, it is therefore possible for colors of the trim and reflectors to be mixed and matched. Of course, the combination of reflector and trim coatings can be done with the square shaped reflector 170, square trim 180, conical shaped reflector 150, or round trim 160.

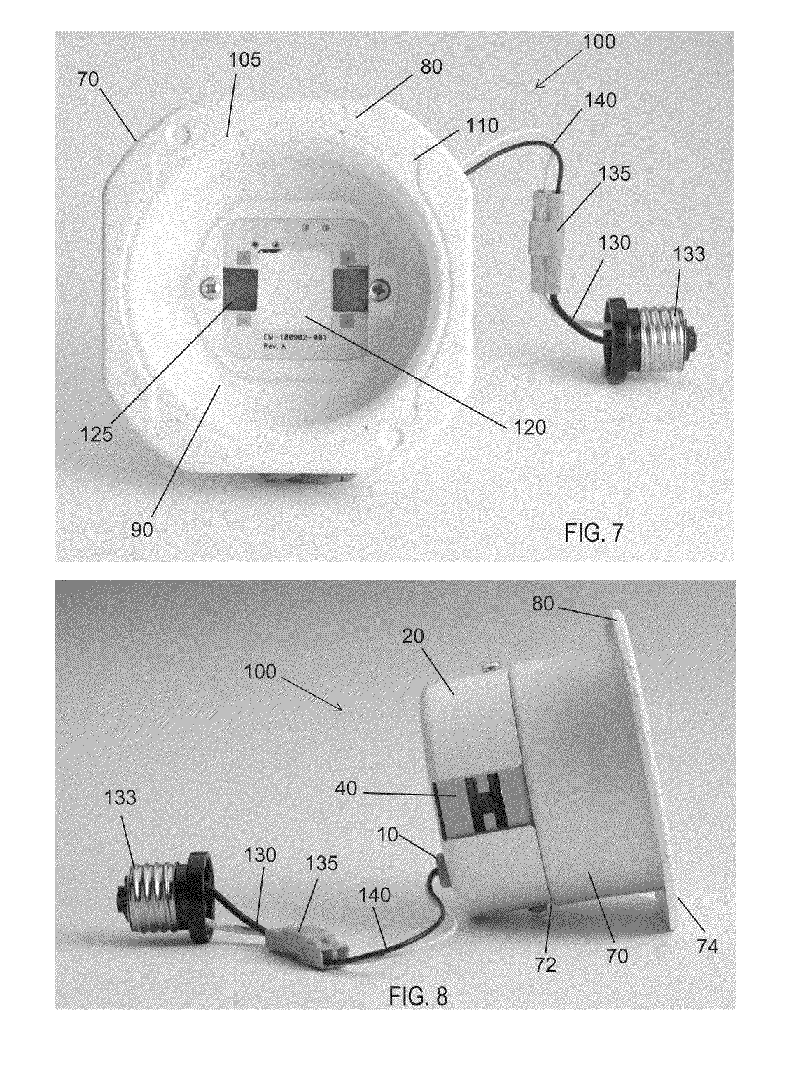

FIG. 6 is a front view of the assembled trim system for luminaires 1 with the interchangeable square shaped reflector 170 and square trim 180. Similarly as with the conical shaped reflector and round trim as described with respect to FIG. 3, the square shaped reflector 170 can be made of aluminum sheet, but can also be made of other magnetic or non-magnetic materials. The square trim 180 can be made of steel such as CRS, but can also be made of other magnetic materials. The square shaped reflector 170 and square trim 180 can be coated with, treated with or formed in a variety of colors such as white, bronze, chrome, black, or brushed nickel. The square shaped reflector 170 and square trim 180 can also be of different shapes and sizes.

According to an embodiment of the present invention, there is a housing 100 adapted for use in a trim system for luminaires. FIGS. 7-10 illustrate examples of the housing 100. The housing 100 comprises: a recessed can 70 terminating at the open outermost front end or surface with a flange 80; a magnetic socket 125 provided inside the recessed can on an internal surface 120; a connector cable 130/140 for electrical connection to the magnetic socket at one end and to a lighting socket of lighting fixture at the other end via a plug 133. According to embodiments, the flange 80 further comprising one or more magnets 60 disposed thereon or therein; the recessed can 70 having one or more tensioned springs/blades 30 located on its outer surface; and the flange 80 being configured for receiving a separately attachable reflector and a separately attachable trim, secured by magnetic connection.

FIG. 7 is a front view of the housing 100 according to an embodiment of the present invention, with the light module 200 removed from a can 70 of the housing 100. The view shows the recessed internal surface 120 of the can 70. The can 70 includes a flange 80 at its front most surface/front end 74 surrounding the perimeter of the can 70. The flange may be provided with a round groove 105 and a square groove 110 on the surface of the flange 80. The round groove 105 and square groove 110 are configured for facilitating changing of the conical shaped reflector 150 or square shaped reflector 170 without having to remove the housing 100 from the ceiling light fixture because the round groove 105 and square groove 110 house both shapes of reflectors. The grooves may provide a tactile indication that the reflector is in place and aligned on the housing 100 as well as keep the reflector from shifting. The magnetic internal surface 120 attaches the magnetic light module 200 to the center of the can 70 via one or more magnetic contacts 125. The magnetic internal surface 120 and magnetic light module 200 allows for ease in changing the light module 200 without the need for tools.

FIG. 8 is a side view of the housing 100 of a trim system for luminaires 1 showing the front surface 74 of the can 70 and back surface/rear end 72 of the 70. In one embodiment of the invention, the housing 100 includes a power supply cover 20 which surrounds a driver 250 (not shown) for the light module 200 which is attached at the back surface 72 of the can 70. The driver provides the electrical power control, particularly for an LED light engine 200. In another embodiment where there is no driver 250, for example use with a differently configured light source, the power supply cover 20 is not needed and only the can 70 is present. The housing comprises one or more brackets 40 on the housing 100, either at the rear surface 72 of can 70 or inside the cover 20. The brackets 40 can be configured as an attachment for the spring 30 as well as for attachment of the driver 250 (not shown). In other embodiments, there is no bracket 40 and the spring 30 is attached to an outer side surface of the can 70 by other means, such as a screw, bolt, clips, adhesives and the like. At the back surface 72 of the can is located a plug entrance 10 for the wiring 140 of the system.

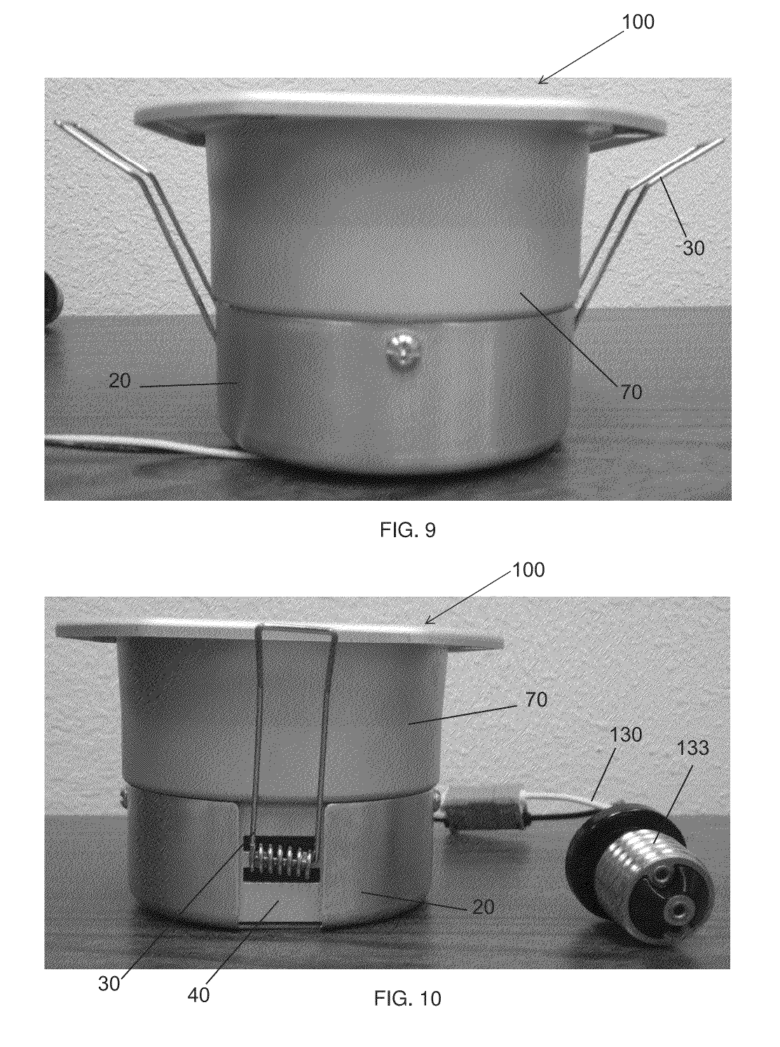

FIG. 9 is a side view of the housing of the trim system for luminaires 1 showing the one of more tensioned spring 30 attached to the bracket 40 on the housing 100 according to an embodiment of the present invention. There are other ways that spring 30 can be attached to the housing 100. As noted above, the spring 30 can be attached to the housing 100 by an adhesive, screw, bolt or another manner. The spring 30 is located as extending or protruding from the external surface of housing 100. There can be one or more springs 30, such as a pair of opposing springs 30 which can be equally spaced apart. Multiple springs 30 do not need to be equidistant apart in other embodiments.

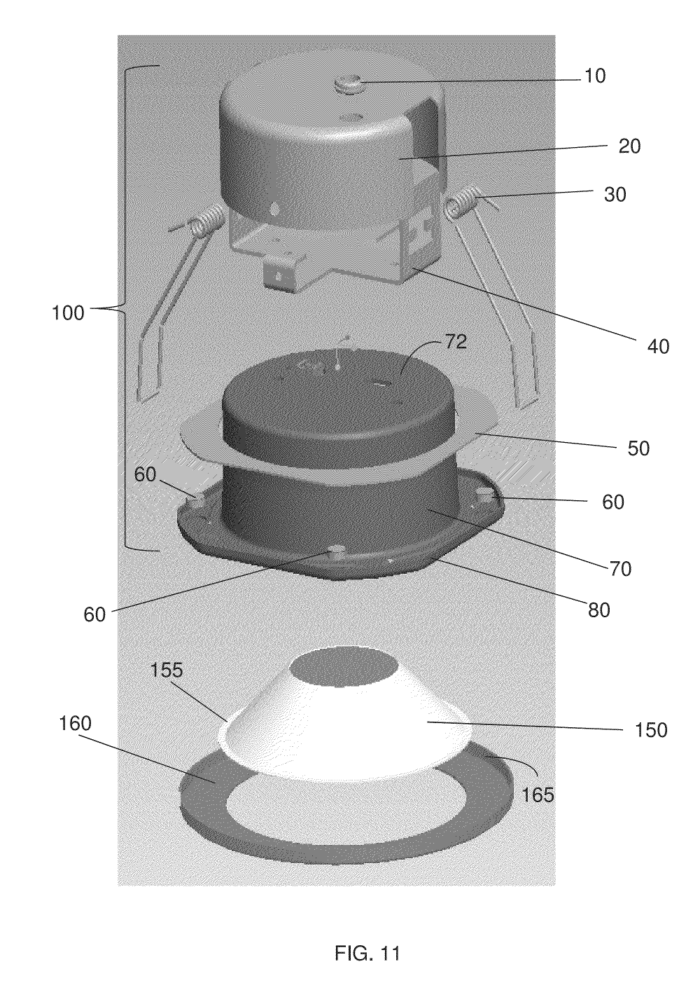

FIG. 10 is another side view of the housing of FIG. 9, showing the positioning of the tensioned springs 30 attached to the bracket 40, one on each side of the housing 100, according to an embodiment of the present invention.

FIG. 11 is an exploded perspective view of a trim system for luminaires 1 comprising an interchangeable conical shaped reflector 150 and round trim 160. A plug entrance 10 on a bottom surface of the housing, for example the bottom of the power supply cover 20, allows the wire 140 and connector cable 130 access to the connection point at the lighting fixture (not shown). The power supply cover 20 is located at the rear surface 72 of the can 70 and covers the driver 250 (not shown) which provides power to the light engine 200 (not shown) for the trim system for luminaires 1. Other embodiments do not include the driver 250 as the trim system for luminaires 1 may be configured for use with various types of light modules.

The springs 30 are located on the housing 100 outer surface, in particular, on the power supply cover 20 or can 70. The springs 30 can be attached to the housing 100 by clipping onto the bracket 40 located inside the power supply cover 20 or by a screw-like mechanism. The springs 30 may protrude somewhat yet rest closely against the housing 100 so long as the springs 30 offer a spring-like resistance contact with the inside surface of a lighting fixture when the housing 100 is inserted inside the lighting fixture. The orientation of the springs 30 can be parallel or perpendicular to the housing 100.

The housing comprises one or more magnets 60, particularly on or near the flange 80. As shown in FIG. 11, there may be four spaced apart circular magnets 60 attached to the underside of the flange 80 of the can 70, at substantially equal distances from each other, according to an embodiment of the present invention. The system may further comprise a decorative ring 50 which hides the appearance of the magnets 60 located on the flange 80 and/or may serve as a gasket when inserted into a lighting fixture.

The components of the housing may be made of cold rolled steel (CRS). The can 70 may be formed of aluminum sheet (e.g. a 3003 can). As shown, a reflector 150 made of aluminum sheet rests inside the can 70 such that the reflector flange 155 rests flush against the flange 80. The trim 160 may be formed of CRS also mounts flush over the reflector 150 and flush upon the flange 80. The trim 160 further comprises a lip 165 at the perimeter of the trim 160, such that when the trim is properly attached and secured to the housing by magnetic connection, the lip 165 surrounds the perimeter of the housing to provide a finished look.

According to an embodiment of the present invention, the magnet is a neodymium magnet. Other types of magnets are contemplated as well. In embodiments, the magnets may be attached by an adhesive such as glue to the underside of the flange 80. In other embodiments, more or less magnets may be used of various sizes and shapes, and need not be positioned equidistant apart on the flange 80 and may be attached by other means. The magnets 60 can be one solid magnet. In another embodiment, there can be at least two separate magnets 60 attached to the flange by an adhesive.

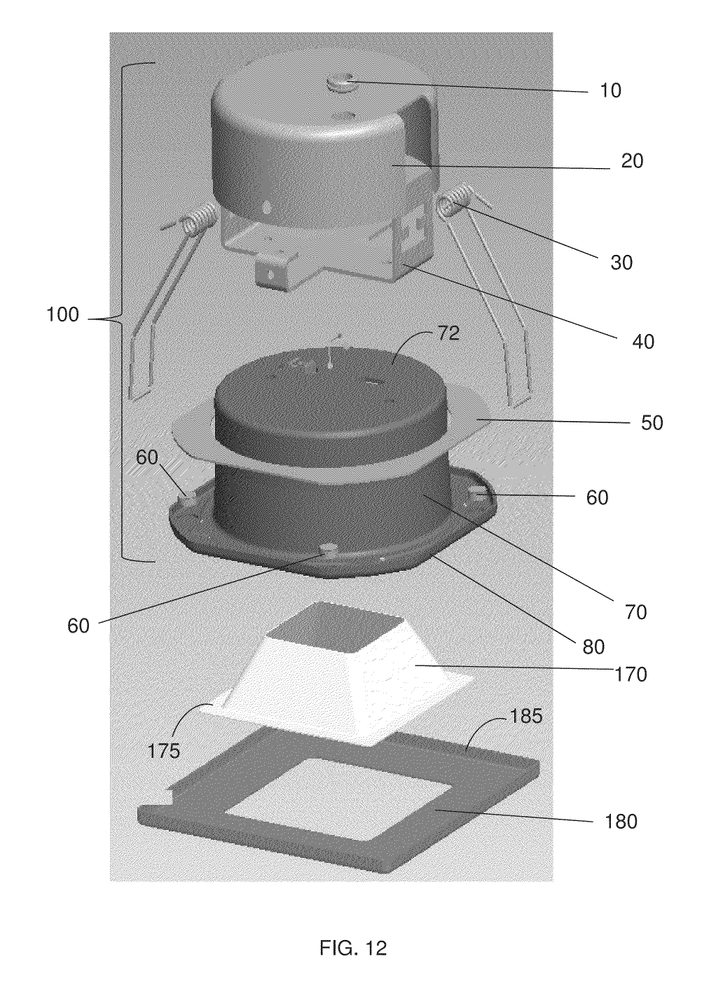

FIG. 12 is an exploded view of the trim system for luminaires as shown in FIG. 11 except for the differently shaped reflector and trim. According to the embodiment, the system comprises an interchangeable square shaped reflector 170 and square trim 180. As shown, a reflector 170 made of aluminum sheet rests inside the can 70 such that the reflector flange 175 rests flush against the flange 80 of the can 70. The trim 180 may be formed of CRS also mounts flush over the reflector 170 and flush upon the flange 80. The trim 180 further comprises a lip 185 at the perimeter of the trim 180, such that when the trim is properly attached and secured to the housing by magnetic connection, the lip 185 surrounds the perimeter of the housing to provide a finished look.

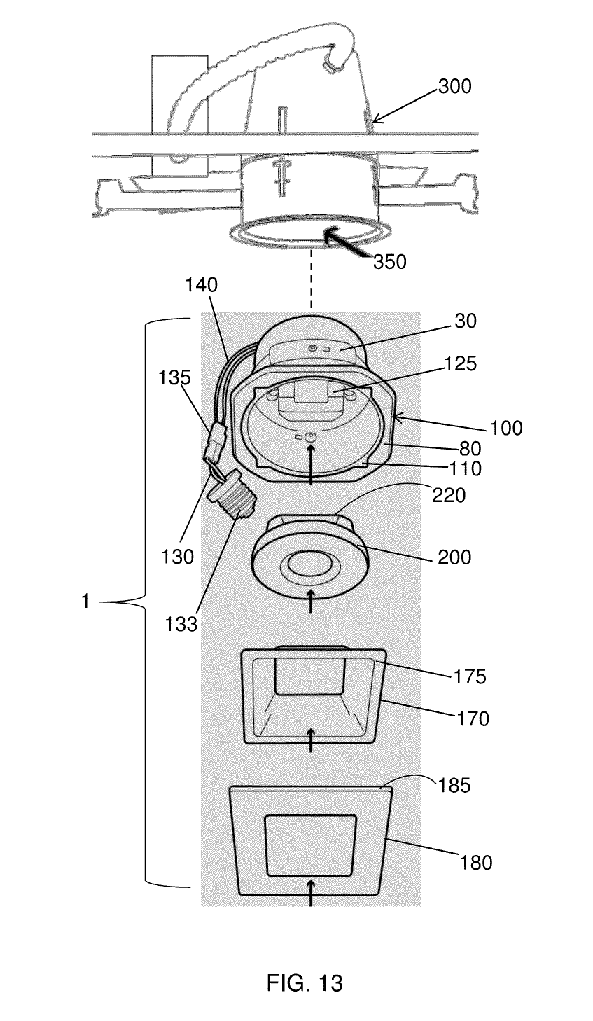

FIG. 13 is illustrates an exploded view of the trim system for luminaires 1 further illustrating a method of installation according to an embodiment of the present invention. The system may be installed as a retrofit kit to existing lighting fixtures. In a method of installation of the trim system according to an embodiment of the present invention, the housing 100 is connected to an empty lighting fixture 300, such as a recessed downlight in the ceiling by screwing the connector cable 130 via the plug 133 (such as medium (E26)) to the electrical socket (not shown) in a ceiling can 350 of the downlight lighting fixture 300. Preferably, the method comprises first detaching the first end connector cable 130 from its connection with the housing 100 at the connector 135 (if not already detached). The connector cable 130 is then connected to the housing by connecting back to the wire 140 via cable connector 135 once the plug 133 is connected. There is at least one tensioned spring 30 located on the exterior surface of the housing 100 that is compressed or squeezed while inserting the housing 100 into the can 350 of the lighting fixture 300. Alternatively, two or more springs 30 can be squeezed, depending on how many springs 30 are present. Once the housing 100 is securely attached into the ceiling can 350, the light module 200 can be magnetically connected to the magnetic internal surface 120 of the housing 100 by carefully aligning the magnetic contact 125 on the bottom surface 220 of light module 200 against the magnetic contact 125 on the magnetic internal surface 120. By the magnetic the contact, the light module 200 should snap into place inside the housing 100. A desired reflector, is set next into the housing 100 over the light module 200. The reflector may be positioned such that the reflector flange 175 may align with groove 110 and rests flush upon the flange 80 of the housing. A desired trim is then placed on the housing, covering the flange 80 and rests flush over the reflector and securely set by the magnetic connection to the housing flange 80. The trim comprises a perimeter lip 185 for aesthetic appeal which fits to surround the perimeter of the housing when set in place providing a finished look.

FIG. 13 shows installation of a reflector 170, then a trim 180 aligned over the reflector 170 and resting flush against each other over the housing flange and secured by magnetic connection. In a preferred method, after the light module 200 is attached inside the housing 100, the trim 180 is held with a rear facing surface of the trim facing an outer facing surface of the flange. Next the reflector 170 is positioned to rest upon the trim 180 and the openings of the reflector and trim are aligned. Both the trim with the reflector are then carefully moved into position onto the flange until the magnets snap the trim into place, such that the reflector and trim are essentially attached to the housing at the same time. When removing the magnetically attached trim, the trim may be pulled off to break the magnetic connection and as a result both the trim and reflector would come undone. In another embodiment, the reflector flange may further be magnetically connected to the housing, such that pulling on the trim away from the flange would leave the reflector still attached.

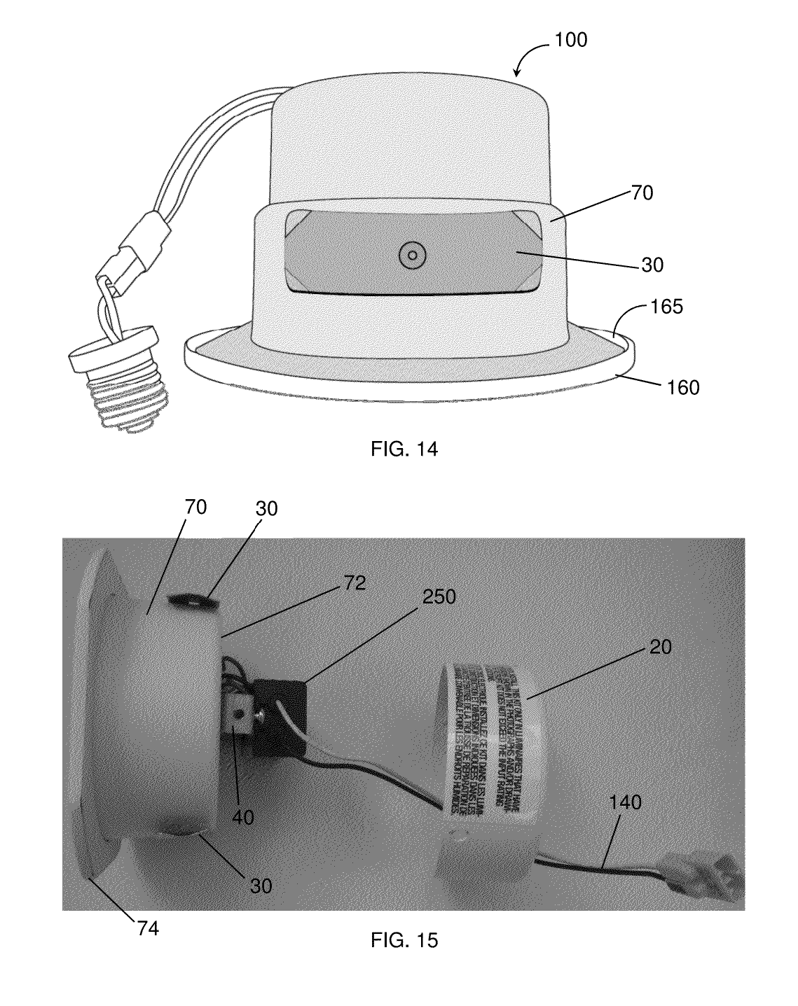

FIG. 14 illustrates a side view the housing 100 showing the tensioned spring blade 30 alongside the outer surface of the can 70. As described, the spring blade edges are squeezed as the housing 100 is pushed into the ceiling can 350 to a point such that the attached trim 160 will rest flush against the ceiling. Upon release of the tension of the spring 30 the housing 100 is set securely inside the lighting fixture 300. As shown, the perimeter lip 165 of the trim 160 surrounds the outer perimeter of the housing and provides for a finished look against the ceiling.

FIG. 15 is a side view of the housing 100 in a disassembled view showing the power supply cover 20 detached from the can 70. As shown in this embodiment, an internally housed driver 250 for the LED driver 200 is connected to the back surface of can 72 via a bracket 40. A pair of tensioned spring blades 30 are connected to an exterior portion of can 70. In other embodiments, the light source may be configured as a different type of light source, or a non-LED module/bulb, not requiring the use of a driver. In such instances, the wire 140 and connector cable 130 are able to connect directly to the light module 200 when a driver 250 is not present.

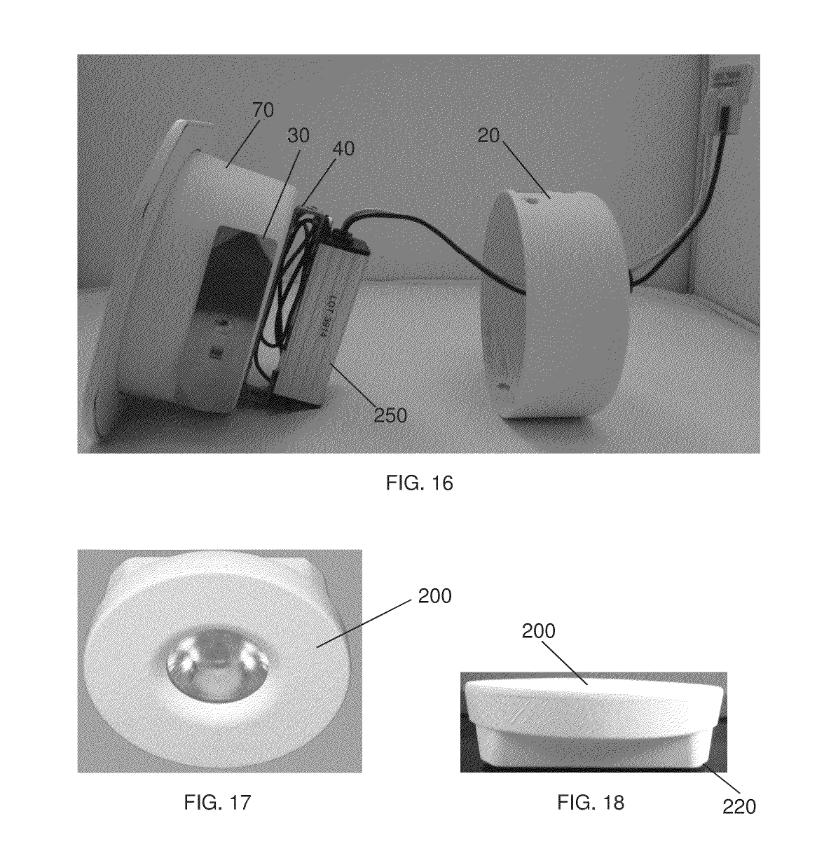

FIG. 16 is another side view of the housing showing the cover 20 detached and revealing the driver 250. A pair of tensioned springs 30 are connected to the exterior portion of the can 70 with a screw or bolt rather than to the bracket 40.

FIG. 17 is a perspective view of a standalone light module 20 disengaged from the magnetic internal surface 120 of a housing 100. FIG. 18 illustrates a side view of the light module shown in FIG. 17. The base 220 of the light module 200 makes magnetic fit contact with the internal surface 120 of the housing. This allows the light module 200 to be easily removable or replaced from the can 70 of the housing 100. The housing may be constructed to retrofit various sizes of lights including 3 inch, 4 inch, 5 inch, 6 inch, and 8 inch. Various choices for magnetic light modules are also contemplated. According to embodiments of the present invention, the system uses a dimmable LED magnetic light engine 200 in which color of the exterior of the engine itself, amount of light output (e.g. 60 W or 75 W), light color (e.g. warm white or soft white), and beam angles (e.g. narrow to wide flood), are customizable. For example, the light engine 200 can have the specification selected from 9.5 watts to 11 watts, 2700 K color temperature to 3000 K color temperature, a beam angle selected from 22 degrees (narrow flood), 36 degrees (flood), 60 degrees (wide flood); 650 lumens to 800 lumens; and an outer diameter of 2¾ inches.

In embodiments, the system allows for the user to easily customize a look using various effects and aesthetics. A user may select shorter to longer beam spreads with lower to brighter lighting, and desire bold to more neutral or subdued looks by interchanging the shapes and color of the reflectors and trims. All of these variations can be used in downlights, retrofit kits, high hat or recessed can lighting. With all the interchangeability of the reflector, trim, color and lighting options, there amounts to at least 1800 variations of the system for luminaires according to embodiments of the present invention.

Although a round trim is shown with a round reflector, it is contemplated that other shaped trims and reflectors are possible. The square trim may further be interchanged with and combined with a round reflector to change the downlight look. Other variations in color and size of trims and reflectors are possible. The system may be configured in size to accommodate various sizes of the light such as 3 in., 4 in., 5 in., 6 in., and 8 in. as discussed above.

According to the solution of the present invention, changing trims and reflectors are made faster and easier, without removing the fixture from the ceiling. The resulting embodiments of the present invention provides for a most universal and flexible downlight system available. The magnetic trim system for luminaires provides for a completely serviceable and upgradeable product without requiring the use of tools.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What claimed is:

1. A trim system for luminaires comprising:
a housing unit having a rear end and a front end,
the front end having a can, the can having a recessed internal surface within which a magnetic socket resides and a flange on an outermost front surface of the can,
a connector cable having a first end and a second end, the first end terminating with a plug outside the housing unit, and the second end connected through the rear end of the housing unit for connection with the magnetic socket;
a light module, removably and magnetically attachable to the magnetic socket on the recessed internal surface of the can;
a removably attachable reflector positioned inside the can abutting the flange, the reflector having an opening aligned over the light module; and
a removably attachable trim separately abutting the reflector, positioned covering the flange and magnetically attaches to the flange.

2. The trim system for luminaires of claim 1, wherein a shape of the housing unit is configured for insertion into an existing lighting fixture.

3. The trim system for luminaires of claim 1, further comprising one or more tensioned springs positioned to protrude from an outer surface of the housing unit.

4. The trim system for luminaires of claim 1, wherein the housing unit further comprises:
a power supply cover at the rear end of the housing unit and connected behind a rear surface of the can; and
a driver housed within the power supply cover, electrically connected to both the magnetic socket and the second end of the connector cable.

5. The trim system for luminaires of claim 1, wherein the reflector comprises a reflector flange extending from a perimeter of an outermost front surface of the reflector parallel to and abutting flush against the flange of the can when aligned.

6. The trim system for luminaires of claim 1, wherein the flange comprises one or more magnets.

7. The trim system for luminaires of claim 1, wherein a front surface of the flange comprises a first set of grooves corresponding to a contact surface of a first shaped reflector for abutting the flange.

8. The trim system for luminaires of claim 7, further comprising a second set of grooves configured differently from the first groove, the second groove corresponding to a contact surface of a different shaped reflector for abutting the flange.

9. The trim system for luminaires of claim 1, wherein the removably attachable reflector is frustoconical in shape and interchangeable with a square frustum shaped reflector, separately from the trim, without the use of tools.

10. The trim system for luminaires of claim 1, wherein the reflector is magnetically attached to the can.

11. The trim system for luminaires of claim 1, wherein the trim is formed of magnetic material.

12. The trim system for luminaires of claim 1, wherein the removably attachable trim is round in shape and interchangeable with a square shaped trim, separately from the reflector, without the use of tools.

13. A housing adapted for use with a trim system for luminaires, the housing comprising:
a recessed can having a rear end, a front end, and a recessed internal surface;
a flange extending from an outermost perimeter of the front end;
a magnetic socket provided on the internal surface configured for contact with a removable magnetic light module;
a connector cable having a first end and a second end, the first end terminating with a plug outside the housing, and the second end connected through the rear end of the housing for electrical connection with the magnetic socket; and
one or more tensioned spring blades provided on an outer surface of the housing;
wherein the flange is configured for receiving a removable reflector abutting the flange over the internal surface, and configured for magnetically receiving a separately removable trim covering the flange.

14. The housing adapted for use with a trim system for luminaires according to claim 13, further comprising one or more magnets disposed on or therein the flange.

15. The housing adapted for use with a trim system for luminaires according to claim 13, wherein the connector cable further comprises a wire connector between the first end and the second end.

16. The housing adapted for use with a trim system for luminaires according to claim 13, wherein the flange comprises one or more sets of grooves corresponding to fit one or more differently shaped contact surfaces of a removable reflector.

17. The housing adapted for use with a trim system for luminaires according to claim 13, further comprising a driver electrically connected to the magnetic socket and connector cable, the driver housed within a power supply cover attached to the rear end of the can.

18. A method for installing a magnetic trim system for luminaires, the system comprising:
a housing unit having a can with a recessed internal surface within which a magnetic socket resides and a flange formed on an outermost front surface of the can;
at least one magnet disposed thereon or therein the flange;
one or more tensioned springs provided on an outer surface of the housing unit;
a connector cable terminating with a plug outside the housing unit at a first end and connected at a second end through a rear surface of the housing unit for connection with the magnetic socket;
a magnetic light module;
a removably attachable reflector; and
a removably attachable trim;
the method comprising:
attaching the plug of the connector cable to an electrical socket of a lighting fixture;
compressing the at least one spring while pushing the housing unit, rear surface first, into the lighting fixture;
aligning and contacting the light module against the magnetic socket of the can;
holding the trim such that an inner facing side of the trim faces the flange;
resting the reflector against the trim such that an outer facing side of the reflector is flush against the inner facing side of the trim; and
moving both the trim with reflector towards the flange until the trim magnetically attaches against the flange.

19. The method according to claim 18, wherein pulling the trim away from the flange detaches the both the trim and the reflector.

20. The method according to claim 18, wherein pulling the trim away from the flange detaches the trim while leaving the reflector magnetically attached.
